(19) United States
(12) Patent Application Publication
(10) Pub. No.: US 2003/0225830 A1
(43) Pub. Date: Dec. 4, 2003

(54) Performance measuring system for storage network

(76) Inventors: Kenji Kataoka, Yokohama (JP); Minoru Koizumi, Yokohama (JP)

Correspondence Address: Mattingly, Stanger & Malur, P.C., Suite 370, 1800 Diagonal Road, Alexandria, VA, 22314, US

(21) Appl. No.: 10/270,552

(22) Filed: Oct. 16, 2002

(30) Foreign Application Priority Data
May 31, 2002 (JP) 2002-158583

(51) Int. Cl. H04B 1/74; G06F 15/16

(52) U.S. Cl. 709/203; 714/43

(57) ABSTRACT

A client connected to an IP network has a unit for adding an inquiry identifier when an inquiry is made to a DB server, and a unit for accumulating time information together with the inquiry identifier when the inquiry is transmitted and a result is received. A DB server connected to the IP network and a storage network has a unit for adding the received inquiry identifier when the result is transmitted to a client and the inquiry is received, and a unit for accumulating time information together with the inquiry identifier when the inquiry is received, when I/O is requested to the storage, when an I/O result is received from the storage, and when the result is transmitted to the client.

### BACKGROUND OF THE INVENTION

The present invention relates to a method for measuring performance characteristics of a database system to gain access to a storage via an IP network.

As management tools for a DB server, a great number of products have already been produced and marketed as described in Nikkei Open System, September 1997 (No. 54) “Performance Improvement Support Tools for RDB”, pp. 283-294.

The management tool is classified according to its intended purpose into three types: DB tuning tool, DB monitoring tool, and load test tool.

The DB tuning tool is to determine bottleneck in a system and gives suggestions on the points to be improved. In the DB server, it is used to measure CPU time for each SQL statement, to detect an SQL statement having strong influence on the performance, and to display graphs for CPU time or I/O waiting for each executed SQL statement.

The DB monitoring tool is to identify the status of the DB server. In the DB server, it is used to monitor CPU load, empty capacity of a disk, and parameters exerting influence on troubles such as number of transactions, and to prevent the troubles.

The load test tool applies load on the DB server using an actual client or a virtual user and measures response time. By analyzing information of the collected response time, load performance of the server is quantitatively determined.

### SUMMARY OF THE INVENTION

Up to now, it has been practiced to measure performance characteristics of storage processing (e.g. SQL statement) either on a DB server side or on a client side. As a result, it is not possible to identify transfer delay time over a network, and this caused difficulties in the analysis of bottleneck or in the identification and elimination of the portion in trouble.

The present invention provides a system, which makes it possible to perform a more elaborate analysis of storage processing.

The system of the present invention includes:

clients for adding an inquiry identifier when an inquiry is transmitted to a DB server, and for accumulating time information together with the inquiry identifier when the inquiry is transmitted and when a result from the DB server is received;

DB servers for adding the received inquiry identifier when the result is transmitted to a client and when the inquiry is received, and for accumulating time information together with the inquiry identifier when the inquiry is received, when I/O is requested to the storage, when an I/O result is received from the storage, and when the result is transmitted to the client; and

a performance measuring server for collecting accumulated data from the client and the DB server, and for measuring delay of communication required for an inquiry, processing time at the DB server, and processing time at the storage respectively, using the inquiry identifier as a key.

### BRIEF DESCRIPTION OF THE DRAWINGS

FIG. 1 is a block diagram showing the entire configuration of a system in a first embodiment of the present invention;

FIG. 2 is a diagram of software configuration of a client computer in the first embodiment of the present invention;

FIG. 3 is a block diagram showing functional configuration of DB connection software in the first embodiment of the present invention;

FIG. 4 shows an inquiry management table in the first embodiment of the present invention;

FIG. 5 shows a measurement rule in the first embodiment of the present invention;

FIG. 6 shows a measurement data table in the first embodiment of the present invention;

FIG. 7 shows a command ID format in the first embodiment of the present invention;

FIG. 8 shows a data format in the first embodiment of the present invention;

FIG. 9 shows software configuration of a DB server in the first embodiment of the present invention;

FIG. 10 is a block diagram showing functional configuration of RDBMS in the first embodiment of the present invention;

FIG. 11 shows a response management table in the first embodiment of the present invention;

FIG. 12 is a block diagram showing functional configuration of an IP meter in the first embodiment of the present invention;

FIG. 13 shows a sequence of flow when cache processing is performed in the first embodiment of the present invention;

FIG. 14 shows a sequence of flow when cache processing is not performed in the first embodiment of the present invention;

FIG. 15 represents functional configuration of a performance measuring server in the first embodiment;

FIG. 16 shows a measurement node management table in the first embodiment;

FIG. 17 shows an example of a measurement result in the first embodiment;

FIG. 18 represents an example of a graph of the measurement result in the first embodiment;

FIG. 19 is a diagram showing functional configuration of RDBMS in a second embodiment of the invention;

FIG. 20 shows software configuration of a storage in the second embodiment;

FIG. 21 shows a measurement rule in the second embodiment; and

FIG. 22 shows a flow of measurement processing in the second embodiment.

### DETAILED DESCRIPTION OF PREFERRED EMBODIMENTS

Descriptions will be given below on embodiments of the present invention referring to the drawings.

(First Embodiment)

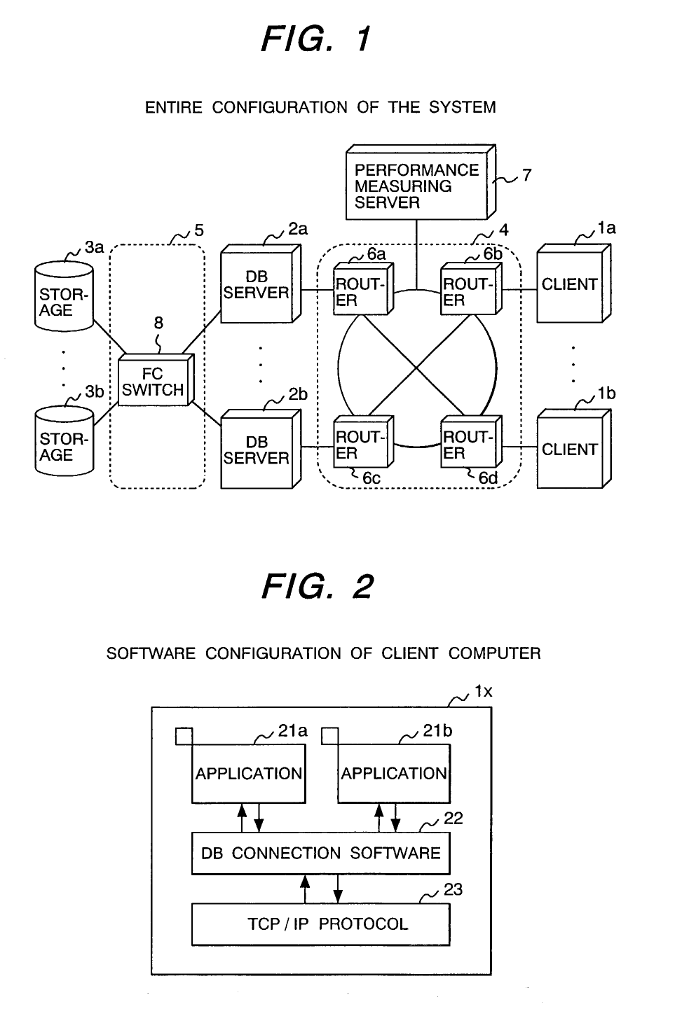

FIG. 1 shows an entire configuration of the system. The system comprises a plurality of client computers 1a, 1b, a plurality of DB servers 2a, 2b, a plurality of storages 3, 3b, to store data, an IP network 4 for connecting the clients with DB servers, and a storage area network (SAN) 5 between the DB servers and the storages. In the IP network, routers 6a, 6b, 6c and 6d are connected with each other. In the SAN, DB servers and the storages are connected with each other via a fibre channel switch 8. A performance measuring server 7 is connected to the IP network. Measurement data is collected from DB servers with measuring functions and from routers and clients, and evaluation and analysis of the storage network system (a whole system from client servers to the storages) are performed. In the present embodiment, a relational database management system (RDBMS) is used as a database management system (DBMS). As control language to read and write DB, SQL is used, which is a common language of RDBMS. Here, the SAN is used as the storage network (to connect the storages with DB servers), while network attached storage (NAS) or SCSI connection of DB servers and the storages may be used.

First, a description will be given on operation of the client computer 1a.

FIG. 2 shows software configuration of the client computer. Applications 21a and 21b designate a DB server along the interface offered by DB connection software 22. By giving an SQL statement and receiving the result, it gains access to the DB server 2a. The DB connection software 22 establishes session with DB server using a TCP/IP protocol 23, and the SQL statement transmitted by the application is sent to the server. Upon receipt of the result from the server, it is delivered to the application. The TCP/IP protocol 23 turns the SQL statement to a packet transferable over the network and transfers it via the network. After sending it to the partner, it plays a role to receive the packet addressed to itself via the network.

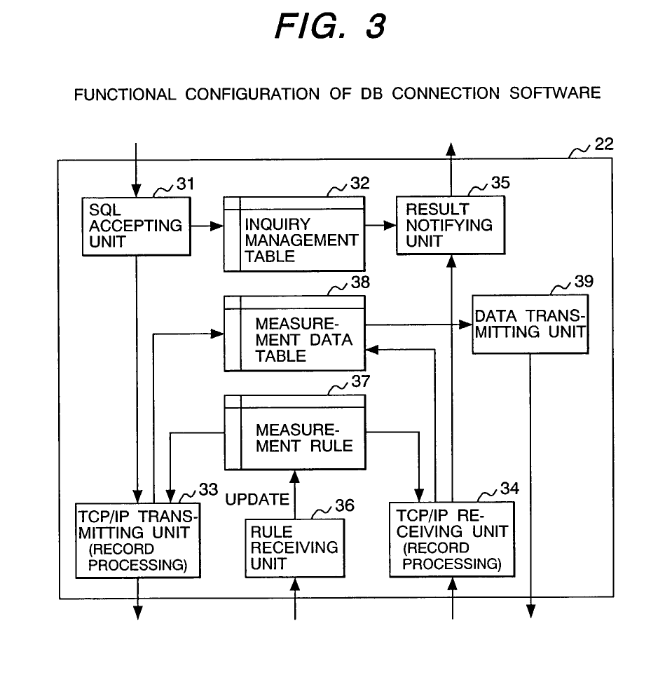

Now, a more detailed description will be given on operation of the DB connection software 22 referring to FIG. 3.

Prior to the explanation on operation of FIG. 3, a description will be given on the details of the table used.

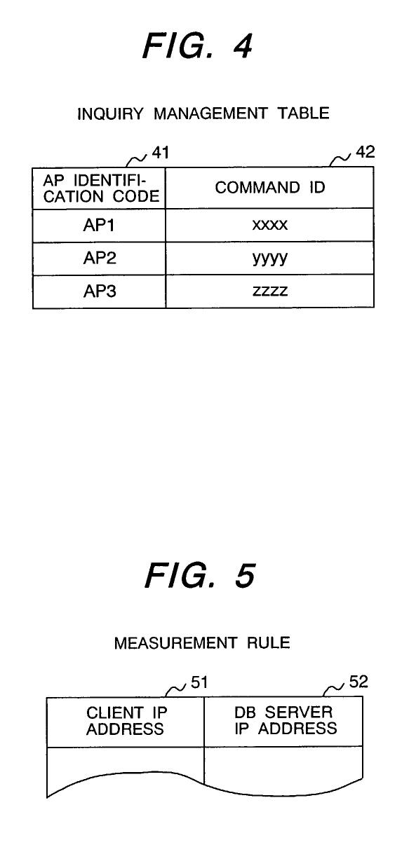

FIG. 4 shows a configuration of an inquiry management table 32. This table specifies as to which application the result is to be delivered when the result to an SQL inquiry is received from DB server, and it is referred by a result notifying unit 35. It comprises a field 41 to set an identification code of the application inquired and a field 42 to set a command ID (to be described later).

FIG. 5 shows a configuration of a measurement rule. A measurement rule 37 is set by a rule receiving unit 36 at a request from a performance measuring server 7. That is, the performance measuring server 7 designates a client or a DB server to be measured. It comprises fields 51 and 52, which are to set IP addresses a of client and a DB server to be measured. If the value is indicated by the mark “*”, it means all the clients or all the DB servers.

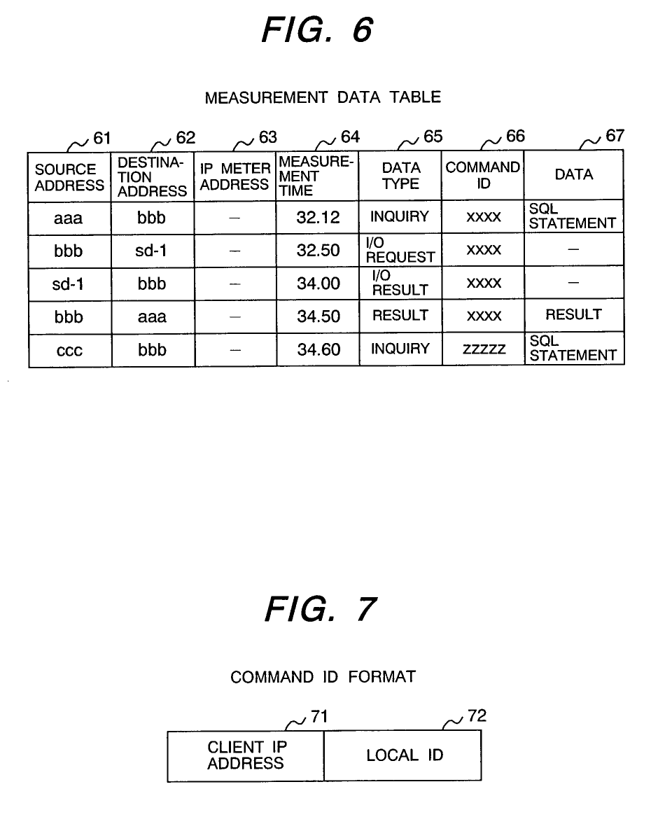

FIG. 6 represents a configuration of a measurement data table 38. This table is used to store the measured data. The same table is also used for DB servers and an IP meter (to be described later). The table comprises fields 61 and 62 for setting addresses of a source and a destination, a field 63 for setting an address of the IP meter, a field 64 for setting measurement time, and fields 65 to 67 for setting a command ID and data. Data type comprises four types of identification codes, i.e. “inquiry” from the client, “result” from the DB server, “I/O request” from the DB server, and “I/O result” from the storage. The IP address field 63 is used only for IP meter. It is not necessary to acquire the data field 67 in duplicate and it may be acquired at any one of the DB server, IP meter or client, and it is used only at the DB server.

The above is the description on the table used. Next, a description will be given on operation.

An SQL statement from the application 21a is delivered to an SQL accepting unit 31. At the SQL accepting unit, a command ID to identify an SQL inquiry is generated, and this is set to an inquiry management table 32 together with an application identification code.

FIG. 7 shows a format of the command ID. It comprises a field 71 for setting an IP address of a client, and a field 72 for setting a consistent number under local management by DB connection software. The IP address is a global address and it is uniquely given in the system. The SQL statement delivered from the application is uniquely specified by this command ID.

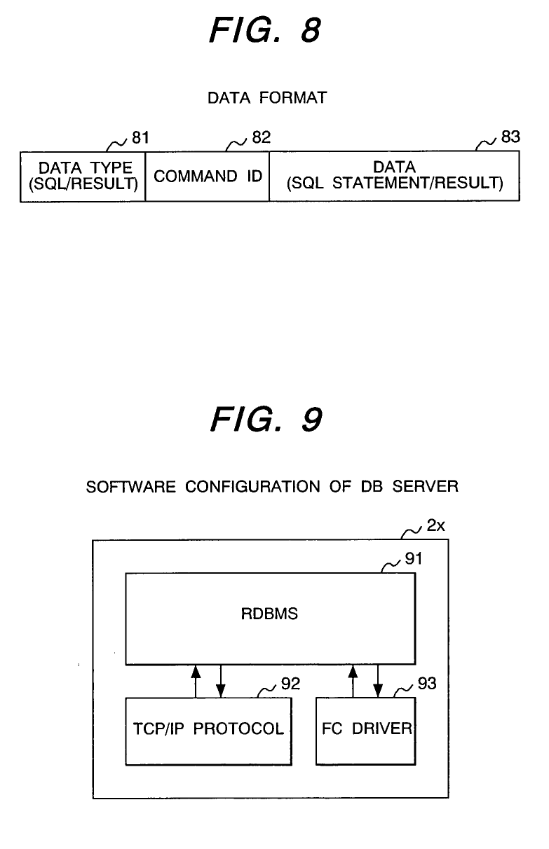

At a TCP/IP transmitting unit 33, data of the format shown in FIG. 8 is prepared from the delivered command ID and the SQL statement, and transmission of the data is requested to the TCP/IP protocol 23. A measurement rule 37 is referred, and if it matches measurement conditions, record processing is performed to a measurement data table 38.

FIG. 8 represents a format of the data to be delivered between a client 1a and a DB server 2a. In a field 81, data type is set, which specifies whether it is an SQL inquiry from the client or a result from DB server. In a field 82, the command ID is set. In a field 83, the SQL statement or the result is set.

In the record processing to the measurement data table 38, the IP address of the client is set to the source, and the IP address of the DB server is set to the destination. Measurement time, data type (inquiry), and a command ID are set respectively.

In TCP/IP protocol 23, the data delivered from the TCP transmitting unit 33 is turned to a TCP/IP packet and is delivered over network to send it to a DB server 2a. Also, the result from the DB server is received and is delivered to a TCP/IP receiving unit 34.

At the TCP/IP receiving unit 34, the received data is delivered to a result notifying unit 35, and the measurement rule 37 is referred. If it matches the measurement conditions, record processing is performed to a measurement data table 38. In the record processing, DB server address is set to the source, and client IP address is set to the destination. Measurement time, data type (inquiry), and a command ID are set respectively.

At the result notifying unit 35, the inquiring application is specified by searching the inquiry management table 32 from the command ID of the data received from the TCP/IP receiving unit 34, and the result is delivered. The recorded measurement data is transferred to a performance measuring server 7 by a data transmitting unit 39. At the rule receiving unit 36, the measurement rule transmitted from the performance measuring server is received, and the measurement rule 37 is updated.

The above is the operation of the client. By this operation, in response to an SQL inquiry between the client and the DB server designated by the performance measuring server 7, SQL inquiry transmitting time and result receiving time from the DB server are recorded on the measurement data table 38.

Next, a description will be given on software configuration and functional configuration of the DB server 2a.

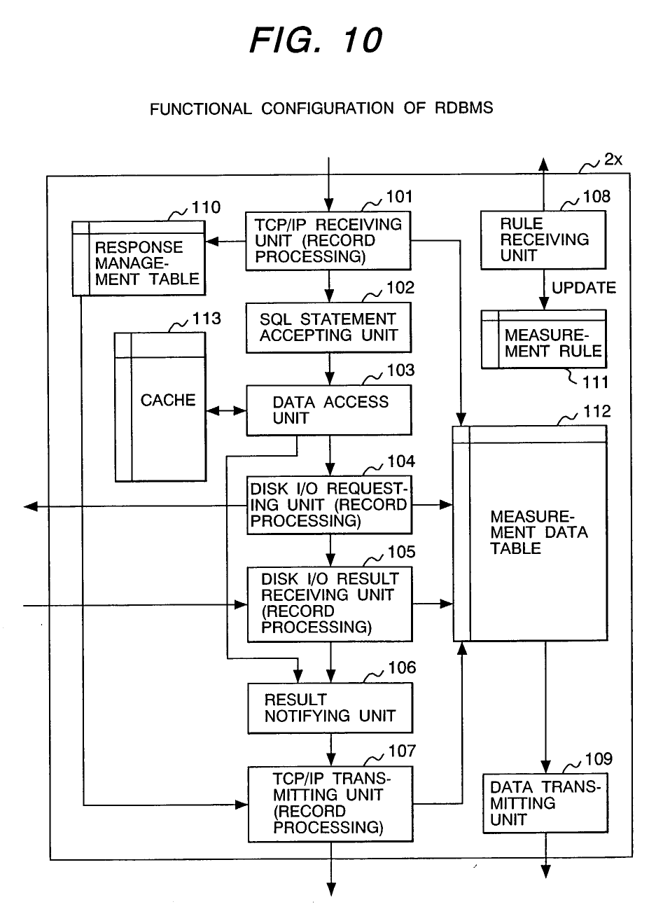

FIG. 9 shows software configuration of DB server. A RDBMS (relational database management system) 91 is software for management of a relational DB. It manages the storage of data to a disk and the retrieval of data from a disk. A TCP/IP protocol 92 transmits and receives information to and from the IP network 4 as described above. An FC driver 93 performs disk I/O processing to the storage 3a, for instance, by using fibre channel. Referring to FIG. 10, a detailed description will be given on operation of the RDBMS 91. The function of the RDBMS is diverse, covering the maintenance of access authority, restoration of data trouble caused by fault, guarantee of consistency of data, simultaneous access from a plurality of users (exclusive control), etc. In the present embodiment, a description will be given only on a part relating to performance measurement of storage. First, the content of the table used is described.

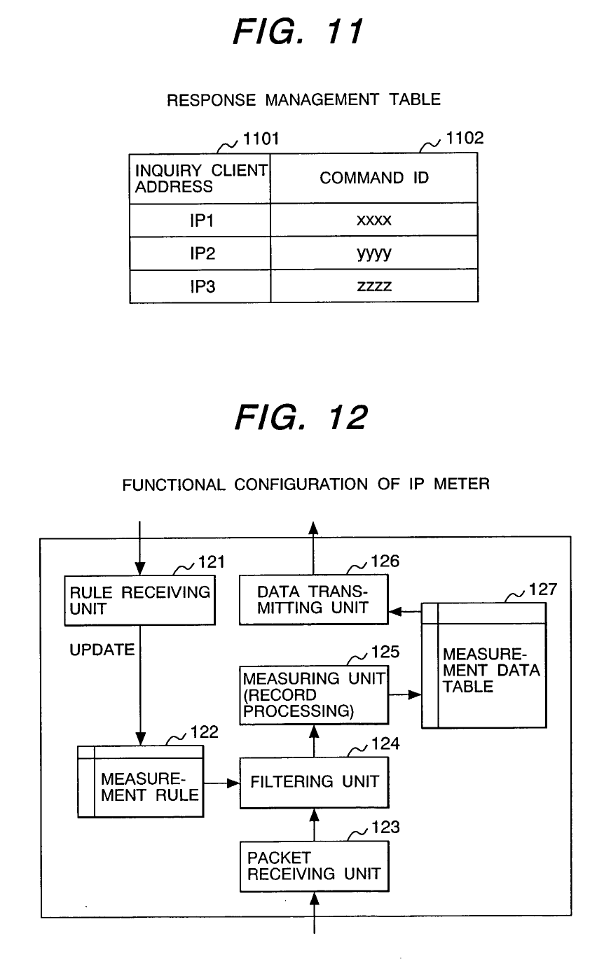

FIG. 11 represents a configuration of a response management table 110. This table corresponds to an inquiry management table operated on the client side, and it comprises fields 1101 and 1102 for setting IP address of the inquiring client and the command ID. By this table, the client of the destination is specified when the result is to be transmitted.

The measurement rule 111 and the measurement data table 112 are the same as the measurement rule 37 and the measurement data table 38 at the client. Next, a description will given on operation.

At the TCP/IP receiving unit 101, an SQL inquiry from the client is received, and the data is delivered to an SQL accepting unit 102. In this case, registration to the response management table 110 and the measurement rule 111 are referred. If it matches the measurement conditions, it is recorded to the measurement data table 112. In this record processing, the IP address of the client is set to the source address, and the IP address of the DB server is set to the destination address. Measurement time, data type (SQL inquiry), command ID and data (SQL statement) are set respectively.

At the SQL accepting unit 102, SQL grammar is checked, and the data is converted to an internal format understandable by RDBMS, and it is delivered to the data access unit 103. At the RDBMS, the number of disk I/O operations is decreased, and a cache 113 is provided so that the processing can be carried out at high speed. When processing can be made on the cache, the data access unit 103 picks up the data from the cache or writes the data to the cache, and the result is delivered to the result notifying unit 106. If the processing cannot be carried out on the cache, a place to store physical block is specified, and the disk I/O is requested to a disk I/O requesting unit 104.

The disk I/O requesting unit 104 converts the data to a fibre channel (FC) protocol, which is a protocol of the SAN, via the FC driver 93, and a disk I/O request is transmitted to a disk concerned. An inquiry to match the measurement rule is recorded on the measurement data table 112.

At the disk I/O result receiving unit 105, when the result is received from the storage via the FC driver 93, the result is delivered to the result notifying unit 106. The inquiry, which matches the measurement rule 11, is recorded to the measurement data table 112.

Whether it matches the measurement rule or not is determined by TCP/IP receiving unit 101 when accepting SQL, and the data is delivered as a parameter to the disk I/O requesting unit 104 and the disk I/O result receiving unit 105 together with the command ID. In this record processing, if the source or the destination is a storage device, a device ID of the storage concerned is set (i.e. sd-1 in column 2 or 3 in FIG. 6). In the data type, a code to identify whether it is a disk I/O request or a disk I/O result is set. Further, time information and command ID are set. Disk I/O may be generated two or more times. In such a case, measurement is made for each disk I/O.

At the result notifying unit 106, using the data acquired from the cache 113 or the data acquired by the disk I/O, the result to be sent back to the client is prepared with a format shown in FIG. 8. Then, it is delivered to a TCP/IP transmitting unit 107.

At the TCP/IP transmitting unit 107, the response management table 110 is referred to, and a client address to be notified is acquired. The measurement rule 111 is referred to. If it matches the measurement conditions, record processing to the measurement data table 112 is carried out. Then, transmission to the TCP/IP protocol 92 is requested.

In this record processing, a DB server IP address is set to the source, and a client IP address is set to the destination. Measurement time, data type (result), command ID, and data (result) are set respectively.

The recorded measurement data is transferred to the performance measuring server 7 by the data transmitting unit 109. At the rule receiving unit 108, the measurement rule transmitted from the performance measuring server is received, and the measurement rule 111 is updated. This is determined by the manager. For instance, it is determined according to the inquiry from the user or according to prediction of occurrence of fault.

In the processing of the RDBMS as described above, in response to an SQL inquiry between the client and the DB server designated by the performance measuring server, SQL inquiry receiving time at the DB server, time to start and to end disk I/O, time to transmit the result to the client, and data (SQL statement (such as a command expressed in plain English)/result) are recorded on the measurement data table 112.

Next, a description will be given on an IP meter, which measures the data handled between the client and the DB server via the IP network 4. An IP meter function is provided at an information processing terminal or in a router as a program. In the present embodiment, it is packaged in an edge router of an IP network. The IP meter may not necessarily be packaged. For instance, in the case transfer time between the client and the DB server is measured and network transfer delay time is not measured, the IP meter may not be packaged. When it is desired to measure up to the network transfer delay time between edge routers, the IP meter is packaged.

FIG. 12 is a block diagram showing a functional configuration of the IP meter. A packet receiving unit 123 reads all packets flowing over the network. At a filtering unit 124, a measurement rule 122 is referred, and the packet necessary for the measurement is selected. Unnecessary packets are discarded, and measurement is not performed. At the filtering unit 124, SA (source address) and DA (destination address) are read from an IP header of the read packet. The type of data set in a TCP data unit is checked, and it is determined whether it is a packet to be measured or not.

If it is a packet requiring the measurement, a measuring unit 125 records it in a measurement data table 127. The measurement data table 127 has the same configuration as that of a DB server. In the record processing of this IP meter, SA and DA of the IP header are set to source/destination address, and the IP address of the IP meter is set to meter address. Then, measurement time, type of data set in the TCP data unit, and a command ID are set.

The measurement data thus recorded is transferred to the performance measuring server 7 by the data transmitting unit 126. Also, the IP meter receives the measurement rule transmitted from the performance measuring server 7 at the rule receiving unit 121, and the measurement rule 122 is updated. By these IP meter functions, the packet of the SQL inquiry between the client and the DB server designated by the performance measuring server and the result are measured. If the data length is too long, the SQL inquiry and result may be divided by the TCP/IP protocol. In this case, the leading packet is measured upon receiving, and some errors may occur.

Clocks of the client, DB server and IP meter must be consistent with each other with high precision. This problem can be solved by the use of GPS (global positioning system) or time coordination by NTP (network time protocol).

At which timing the measurement is made in response to an SQL inquiry between the client and the DB server designated by the performance measuring server 7 by the measuring functions of clients and DB servers and by IP meter function provided on the edge router? This will be briefly explained below.

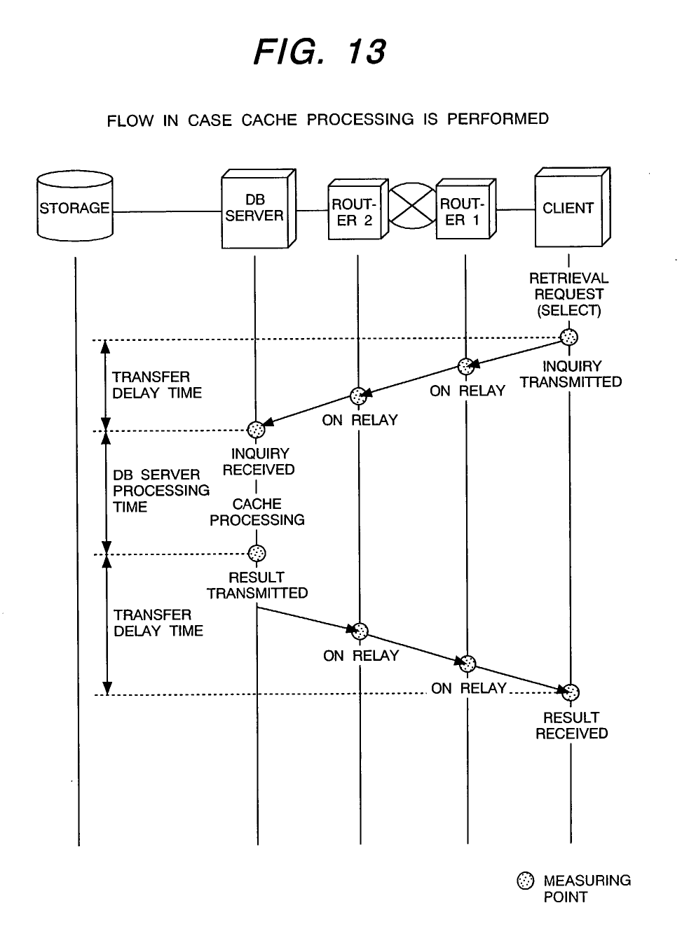

FIG. 13 shows a sequence of flow in the case cache processing is performed in the DB server to a retrieval request from a client 1a. First, the retrieval request of the client is measured when the SQL inquiry is transmitted. It is converted to a TCP/IP packet by the TCP/IP protocol, and it is delivered to the DB server via an IP network. In this case, measurement during relay of the TCP/IP packet of the SQL inquiry is carried out at the edge router provided with IP meter function.

The DB server performs measurement when the SQL inquiry is received and when the result is transmitted, and the result is transmitted to the client. A retrieval result from the DB server is also converted to a TCP/IP packet similarly to the retrieval request, and measurement is performed on the edge router, over which it is sent. As a result, it is possible to measure network transfer delay time between the client and the DB server, processing time at the DB server, and relay time of each router on the IP network.

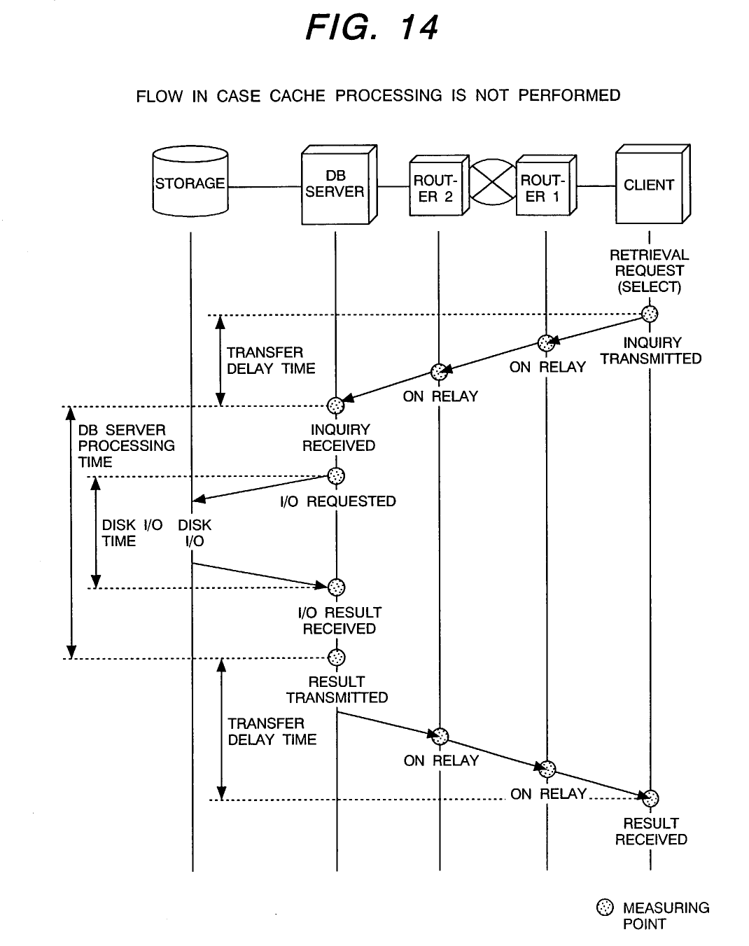

FIG. 14 shows a sequence of flow in the case cache processing is not performed to retrieval request from the client. Measurement processing between the client and the DB server is the same as the case shown in FIG. 13. At the DB server, measurement is carried out when disk I/O is requested, and when a disk I/O result is received from the storage, and it is possible to measure disk I/O time.

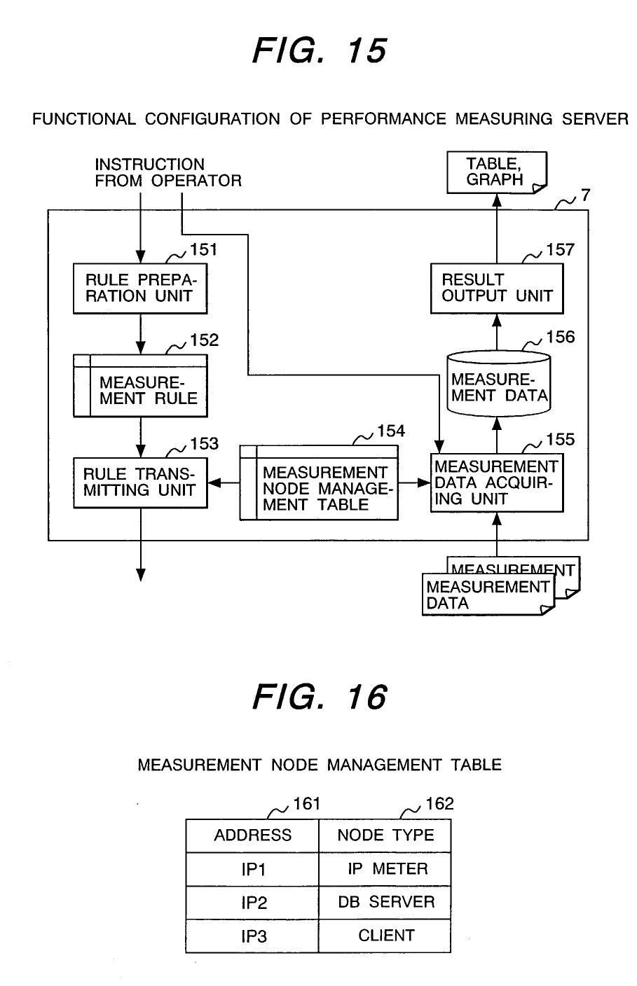

Finally, a description will be given on operation of the performance measuring server referring to FIG. 15. First, the method for setting the performance measurement rule is described. A rule preparing unit 151 prepares a measurement rule when the client and the DB server to be measured are designated by an operator, and this is registered in a measurement rule 152. The details of the measurement rule (FIG. 5) have already been described. A rule transmitting unit 153 receives the measurement rule, and this is transmitted to the IP meter registered on a measurement node management table 154 and to the DB server and the client to be measured. On the measurement node management table 154, the IP meter, DB server, and client are registered. As shown in FIG. 16, the measurement node management table 154 comprises a field 161 for setting an IP address, and a field 162 for setting the node type to identify the IP meter, DB server or client.

Next, a description will be given on operation to collect the measurement data and to display the result of analysis. Collection and analysis of the measurement data are carried out at the instruction by the operator.

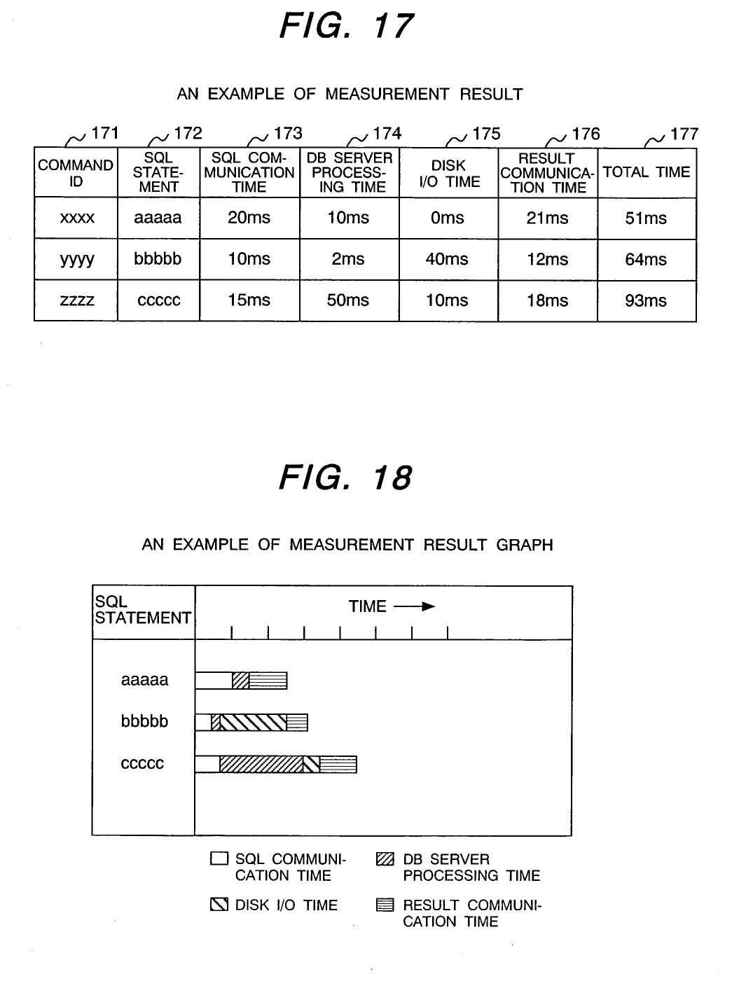

A measurement data acquiring unit 155 transmits a request to acquire measurement data to a DB server and a client to be measured and an IP meter registered on the measurement node management table 154. As a response to it, measurement data is received and is stored. At a result output unit 157, entries having a consistent command ID are searched sequentially from the measurement data of DB server, client and IP meter after acquiring the measurement data, and the time required for processing is calculated from a preset time information. Then, a result shown in FIG. 17 or a graph shown in FIG. 18 is outputted.

In FIG. 17, time to the arrival of an inquiry from the client to the DB server, processing time at the DB server, disk I/O time, time required for the arrival of a result from the DB server to the client, and total processing time (fields 173 to 177) are displayed for each SQL inquiry. As a result, a bottleneck analysis can be performed for each SQL. Also, transfer delay time over network and processing time on the DB server can be differentiated and identified. The result is utilized for the procedure such as the grade-up of ability of the DB server or the increase of capacity of the cache so that empty router can be used by changing the setting for the routers.

FIG. 18 is a graphic representation of the table shown in FIG. 17. By this graph, processing time of an SQL inquiry can be visualized. From the graph, it is apparent that there is a big difference according to the SQL statement in DB server processing time, I/O time, etc.

(Second Embodiment)

In the second embodiment, measurement processing is performed by an IP meter installed on an IP network and by an FC meter installed on a storage network.

First, a description will be given on operation of the client. At the client, measurement processing is not performed, and the processing for the measurement is not needed. The measurement rule 37, the rule receiving unit 36 to update the measurement rule, the measurement data table 38 for recording the measurement data, and the data transmitting unit 39 to transmit the measurement data as explained in the first embodiment (FIG. 3) are not required. The processing to record the measurement data at the TCP/IP transmitting unit 33 and the TCP/IP receiving unit 34 is not required, either. An SQL inquiry received from the application is transmitted to a DB server. The processing to transmit the SQL inquiry received from the application to the DB server and to deliver the result received from the DB server to the application is the same as in the first embodiment.

Next, operation of DB server will be described. Measurement processing is not performed for the DB server, and the processing for measurement is not needed. Similarly to the case of the client, the rule receiving unit, the measurement rule, the measurement data table, and the data transmitting unit are not required. Also, the processing to record each measurement is not required.

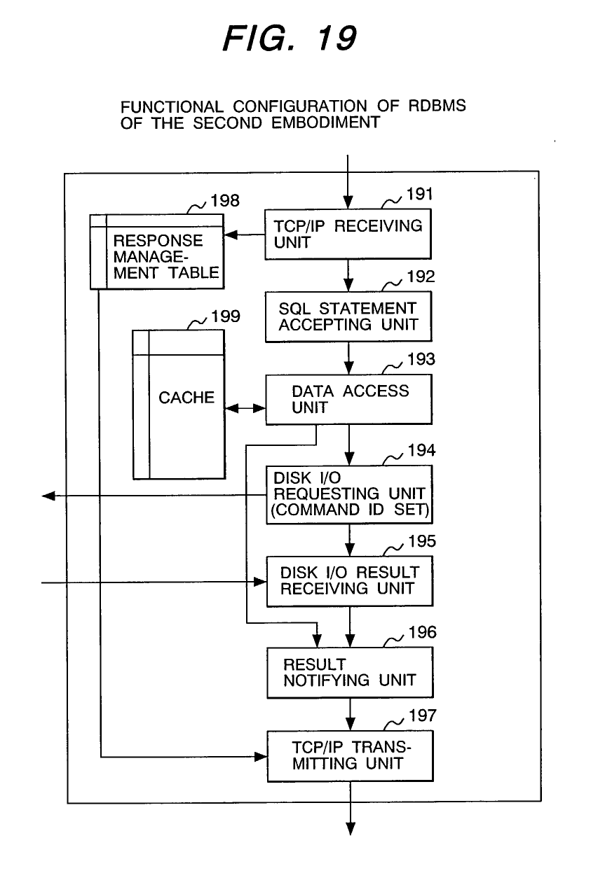

FIG. 19 shows a functional configuration of RDBMS in the second embodiment.

Basically, the difference from the first embodiment is that the processing to record the measurement is not required and that the details of the processing of a disk I/O requesting unit 194 for access processing with the storage are changed. A description will be given below on the difference. In the disk I/O requesting unit, when disk I/O is requested, the data is turned to an FC packet and is transmitted to the storage concerned via an FC driver. In this case, a command ID is added, which has been set to the data field of the FC packet when the inquiry was received. In the case there are two or more transmissions of FD packets, a command ID is added to the data field of each FC packet.

The processing after receiving of the I/O request result from the storage at a disk I/O result receiving unit 195 is the same as in the first embodiment.

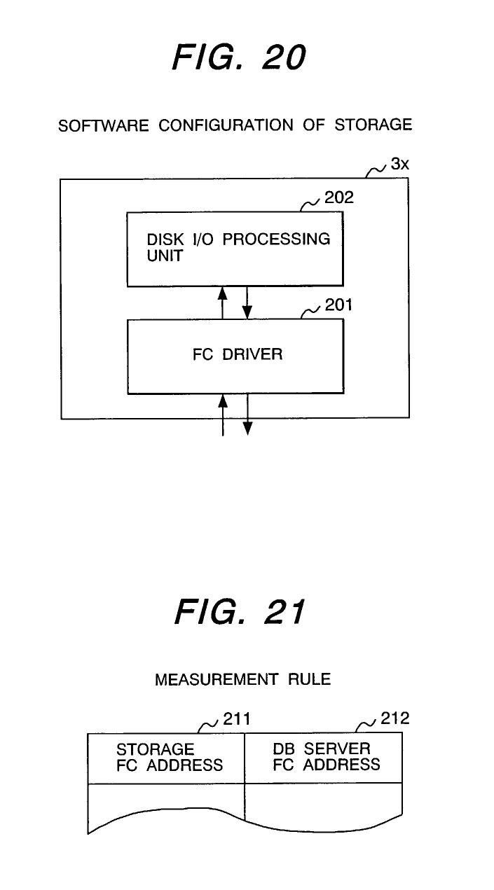

Referring to FIG. 20, a description is now given on operation of the storage. In the functional configuration, it comprises an FC driver unit 201 and a disk I/O processing unit 202. At the disk I/O processing unit, when an FC packet is received via the FC driver, a command ID is acquired from the data field. Then, information of a place of physical block for I/O is read out. The head is operated, and the data is read and written. A disk I/O result is turned to the FC packet via the FC driver and it is transmitted to the DB server concerned. In this case, a command ID, which has been set when a disk I/O request was received, is added to the data field of the FC packet.

Next, a description will be given on processing of IP meter and FC meter for measurement processing. The FC meter is one of storage meters, which are connected to the network to connect the storages and to perform measurement. It is a storage meter in the case the storages are connected over a fibre channel.

The processing of the IP meter is the same as in the first embodiment, and a detailed description is not given here. The functional configuration of the FC meter is the same as the functional configuration (FIG. 12) of the IP meter except that what is to be measured is changed from IP packet to FC packet. In this embodiment, the FC meter is provided in an FC switch 8, and an FC packet is captured using mirroring function. Also, the FC meter is connected to an IP protocol for the purpose of updating the measurement rule and of transmitting the measurement data.

The processing unit corresponding to the packet receiving unit 123 reads all FC packets flowing over the FC switch. It is a processing unit corresponding to the filtering unit 124. It refers to the rule corresponding to the measurement rule 122, selects the FC packet necessary for the measurement, discards an unnecessary FC packet, and does not carry out measurement processing.

The measurement rule gives FC addresses of storages and DB servers as shown in FIG. 21. At the filtering unit, FC header, SA (source address) and DA (destination address) are read, and it is determined whether it is a packet to be measured or not.

If it is an FC packet to be measured, the processing unit corresponding to the measuring unit 125 records it to the processing unit, which corresponds to the measurement data table 127. The measurement data table has the same configuration as in the first embodiment.

In the record processing of the FC meter, SA and DA of the FC header are set to the source/destination address. Measurement time and command ID in the FC data field are set.

The recorded measurement data is transferred to the performance measuring server 7 by the data transmitting unit 126. At a processing unit corresponding to the rule receiving unit 121, a rule corresponding to the measurement rule transmitted from the performance measuring server is received, and the rule corresponding to the measurement rule 122 is updated.

The performance measuring server transmits the IP addresses of the client and the DB server to be measured as the measurement rule to the IP meter. To the FC meter, it transmits the FC addresses of the storage and the DB server to be measured as the measurement rule.

At the IP meter and the FC meter, the measurement rule is received. The IP packet and FC packet concerned are captured, and these are accumulated in the measurement data table respectively.

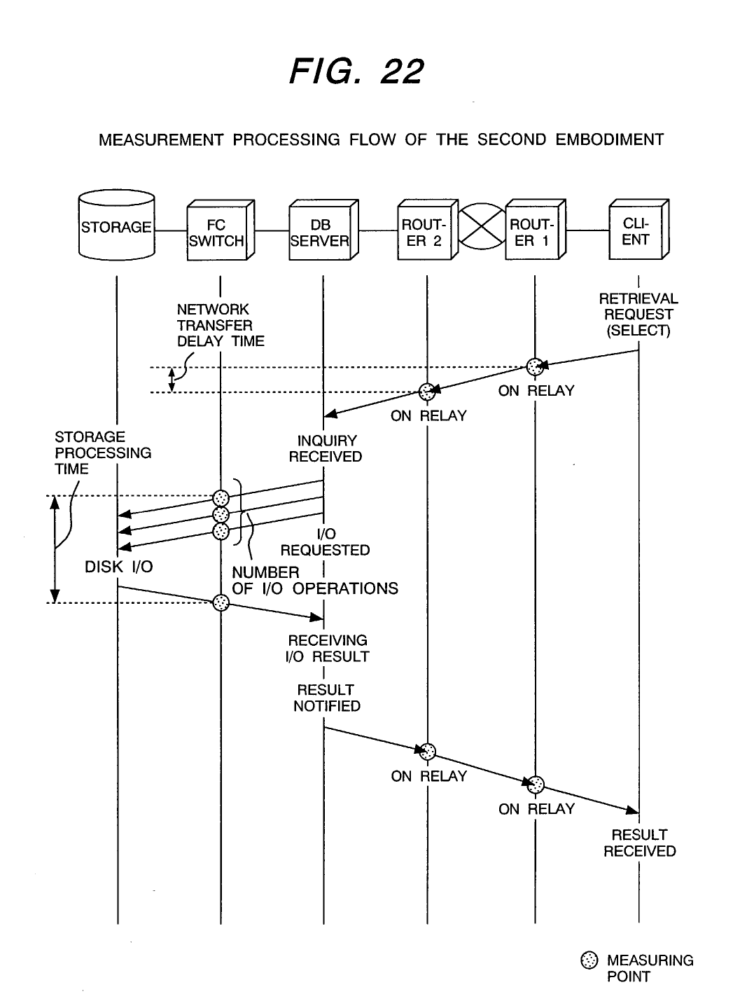

In the FC packet, a command ID of the SQL inquiry generated is set. In this respect, by searching an entry having a consistent command ID from the measurement data of the IP meter and FC meter, it is possible to analyze the data such as storage processing time, number of storage I/O operations, network transfer delay time, etc. as shown in FIG. 22.

By the above embodiment, it is possible to perform an elaborate and detailed analysis and to efficiently carry out an analysis of bottleneck of storage performance, DB tuning, etc.

Further, in the identification at the time of fault, it is possible clearly specify whether it is a problem due to the DB server/storage or a problem due to the network.

As described above, it is possible to measure the performance characteristics of the system over different types of networks.

What is claimed is:

1. A storage network performance measuring system in a database system for gaining access to a storage via IP network and DB server, said performance measuring system comprising:
a client connected to said IP network, having means for adding an inquiry identifier when an inquiry is transmitted to said DB server, and means for accumulating time information together with an inquiry identifier when the inquiry is transmitted and a result for said DB server is received;
a DB server having means for adding the inquiry identifier which is received when the inquiry is received when a result of access to said storage is transmitted to said client, and means for accumulating time information together with the inquiry identifier when inquiry is received, when I/O is requested to said storage, when an I/O result from said storage is received, and when the result is sent to said client; and
a performance measuring server having means for collecting accumulated data from said client and said DB server, and for measuring delay of communication required for the inquiry, DB server processing time, and storage processing time respectively using the inquiry identifier as a key.

2. A storage network performance measuring system according to claim 1, wherein said system further comprises an IP meter having means for capturing a packet of said inquiry and said result from a transfer packet on said IP network and for accumulating time information together with the inquiry identifier.

3. A storage network performance measuring system according to claim 2, wherein said IP meter is provided on an edge router on said IP network.

4. A storage network performance measuring system according to claim 1, wherein said performance measuring server comprises means for outputting the delay of communication required for the inquiry, DB server processing time and storage processing time.

5. A storage network performance measuring system according to claim 1, wherein said performance measuring server stores IP addresses of the client and the DB server to be measured in said client and said DB server.

6. A storage network performance measuring system according to claim 1, wherein said storage is connected to a storage network of a type different from the IP network, said DB server is connected to said IP network and said storage network, said DB server receives the inquiry from said client and transmits an access result to said storage by a protocol of IP network, and an I/O request to said storage and receiving of an I/O result from said storage are performed by a protocol of said storage network.

7. A storage network performance measuring system in a database system for gaining access to a storage connected to a storage network via an IP network and a DB server, said performance measuring system comprising:
a client having means to add an inquiry identifier when an inquiry is transmitted to said DB server;
a DB server connected to said storage network and having means for adding the inquiry identifier received when a result is transmitted to said client and when the inquiry is received, and means for adding a corresponding inquiry identifier when an I/O request is transmitted to the storage;
a storage having means to add the inquiry identifier which is received when I/O is requested, when the I/O result is transmitted to said DB server;
an IP meter having means for capturing a packet of said inquiry and said result from a transfer packet on said IP network and for accumulating time information together with the inquiry identifier;
a storage meter having means for capturing a packet of an I/O request and a packet of an I/O result from a transfer packet on said storage network and for accumulating time information together with the inquiry identifier; and
a performance measuring server having means for collecting accumulated data from said IP meter and the storage meter and for measuring transfer delay of the packet generated by an inquiry using the inquiry identifier as a key.

8. A storage network performance measuring system according to claim 7, wherein said performance measuring server obtains IP network transfer delay time from the information accumulated in said IP meter.

9. A storage network performance measuring system according to claim 7, wherein said storage network is a SAN, and said storage meter is provided on a fibre channel switch of said SAN.

10. A transfer performance measuring system in a system where different types of networks are present, said performance measuring system comprising:
accumulating means installed on each network, for capturing a packet to be transferred in each network and for accumulating the packet together with time information;
a protocol conversion node connected to a plurality of different types of networks, for associating the packets transferred between different types of networks by protocol conversion; and
means connected to one of said different types of networks, for measuring delay of transfer of data over different types of networks from the information accumulated in said accumulating means.
